(19) United States
(12) Patent Application Publication
(10) Pub. No.: US 2017/0142233 A1
(43) Pub. Date: May 18, 2017

(54) MULTI-PATH TCP COMMUNICATION METHOD BETWEEN TWO TERMINALS

(71) Applicant: Orange, Paris (FR)

(72) Inventors: Mohamed Boucadair, Betton (FR); Christian Jacquenet, Pont-pean (FR)

(21) Appl. No.: 15/322,922

(22) PCT Filed: Jun. 26, 2015
(86) PCT No.: PCT/FR2015/051744

§ 371 Date: Dec. 29, 2016

(30) Foreign Application Priority Data
Jun. 30, 2014 (FR) 1456202

(51) Int. Cl. H04L 29/06; H04L 12/24; H04L 29/14

(52) U.S. Cl. CPC H04L 69/163; H04L 69/161; H04L 69/14; H04L 69/40; H04L 41/0654

(57) ABSTRACT

A transmission control protocol (TCP) communication method includes: a) a first client device or a first relay device connected to the first client device sending to a second client device or to a second relay device connected to the second client device a message for initializing a TCP connection on a “first” path, the message including a TCP option indicating that the first client device or the first relay device seeks to participate both in a TCP connection and in a multipath connection over the first path; b) the devices participating in a TCP connection and in a multipath connection over the first path; and c) if at least one of the two client devices or one of the two relay devices observes an anomaly concerning the multipath connection, the first client device and the second client device using the TCP connection to exchange payload data.

### CROSS-REFERENCE TO RELATED APPLICATIONS

This application is a Section 371 National Stage application of International Application No. PCT/FR2015/051744, filed Jun. 26, 2015, the content of which is incorporated herein by reference in its entirety, and published as WO 2016/001543 on Jan. 7, 2015, not in English.

### FIELD OF THE DISCLOSURE

The present invention relates to the field of telecommunications, and in particular communications networks suitable for implementing the Internet protocol (IP). More particularly, the present invention relates to supplying “added-value” services in IP networks, i.e. networks that are capable of performing differentiated treatments depending on the nature of the data traffic conveyed in the network.

The invention applies to any type of client device such as a fixed or mobile terminal, or a residential gateway or a business gateway, or an operator gateway, or indeed a TV decoder (also known as a “set-top-box” (STB)). For reasons of concision, a client device of any type is often referred to below as a “terminal”.

### BACKGROUND OF THE DISCLOSURE

Terminals, such as smartphones and personal computers (PC) are nowadays capable of activating and using a plurality of logic interfaces associated with one or more physical interfaces. Such terminals are said to be multi-interface (MIF) terminals. When a terminal has a plurality of interfaces capable of connecting to different access networks (e.g.: fixed, mobile, or wireless local area network (WLAN)), it benefits from access that is said to be “hybrid” since it combines different access network technologies.

A plurality of IP addresses can then be allocated to such MIF terminals so that they can connect to different types of network, such as a fixed network, a mobile network, or a WLAN, in simultaneous manner or in deferred manner. These IP addresses may:
belong to the same family of addresses or to two different families of addresses (IPv4, IPv6, or both);
have different lifetimes;
have different coverage ranges, e.g. a private IPv4 address, a unique IPv6 address having local range (unique local address or (ULA)), or an IPv6 address of global range (global unicast address (GUA)); and
be allocated to the same logic network interface or to different logic network interfaces.

Nevertheless, is should be observed that the “MIF” characteristic is volatile, since the capability of using a plurality of interfaces depends on network connection conditions, on the location of the device, or on other factors. In particular, a MIF device can make use of the plurality of interfaces available to it while setting up a simple connection (i.e. a connection that is set up along a single path to a given party), or indeed after setting up a simple connection. It should also be observed that a device does not know a priori whether it is possible to use a plurality of distinct paths for setting up a connection with a given party; more precisely, the device acquires this information (where applicable) only at the end of a stage during which it attempts to set up a connection using multiple paths with that party.

It should be recalled that a “multipath connection” is a connection set up between two devices making use simultaneously of one or more paths between the two devices. Such a connection applies a dedicated protocol such as multipath TCP (MPTCP), which may be defined as being an extension of a previously-defined transport protocol such as transmission control protocol (TCP). In other words, a multipath connection is an aggregation of one or more simple connections using a single path or paths that are different (partially or completely disjoint).

It should also be recalled that the TCP protocol, as defined in particular in the Internet engineering task force (IETF) specification RFC 793, is one of the main protocols used by terminals connected to an IP network (e.g. the Internet), such that the literature often mentions the “TCP/IP” protocol suite. The TCP protocol makes it possible in reliable, ordered, and error-free manner to convey a digital data stream between applications that are being executed on terminals connected to a local network (e.g. an Intranet) or to the Internet. It operates at the transport layer level of the open source interconnection (OSI) model. Web browsers use the TCP protocol when they connect to remote servers; the TCP protocol is also used for conveying email or for transferring files from one location to another. Protocols such as HTTP, HTTPS, SMTP, POP3, IMAP, SSH, FTP, Telnet, and numerous other protocols are transported over TCP connections. A TCP connection is identified by the address and the port number of the source terminal and by the address and the port number of the destination terminal.

Two terminals may insert so-called “TCP options” in the TCP messages they exchange, e.g. in order to optimize the quality of TCP transmission. Such options occupy the space available at the end of the TCP header, and they are of a length that is expressed in octets. The kind of option is a unique identifier describing the nature of the TCP option. For example, the value “0” indicates the end of the list of options, and the value “2” indicates the maximum size of the TCP segment, referred to as the maximum segment size (MSS).

The arrival of MIF terminals introduces additional complexity for using some or all of the IP addresses allocated via the available networks. In particular, given that TCP connections are associated with an IP address and a port number, any modification to this information will penalize the operation of an on-going TCP connection, and as a result the operation of the service using said TCP connection. Such a change is particularly troublesome when the terminal is given a new IP address, either because the terminal is connecting to another network or indeed when the interface at which the IP address is associated is no longer available. For example, means for informing a remote TCP party that an IP address is no longer valid are then required in order to ensure that a remote connection is maintained.

In 2009, the IETF commissioned the mptcp workgroup in order to specify extensions to the TCP protocol capable of accommodating constraints imposed by the possibility of allocating a plurality of IP addresses to various physical or logical interfaces of a terminal. That workgroup has published initial specifications for the MPTCP protocol (cf. A. Ford, C. Raiciu, and M. Handley “TCP extensions for multipath operations with multiple addresses”, RFC 6824, January 2013), and some smartphones and operating systems are already capable of implementing them. The IETF expects to raise the status of present-day MPTCP “specifications” so that they become genuine “standards” in the meaning of the IETF.

The MPTCP protocol has thus been proposed to minimize any risk of a TCP connection being interrupted in untimely manner associated with such changes of addressing, and more generally to satisfy the requirements made necessary by a context in which a terminal has the ability to connect to one or more networks via one or more interfaces. The MPTCP protocol serves in particular to satisfy the need to ensure session continuity for a terminal that is mobile. Various circumstances of use can be envisaged for the MPTCP protocol, such as:
transferring traffic between a plurality of WLAN access points;
off-loading a mobile network, and transferring traffic to a WLAN access point;
aggregating a plurality of access links;
sharing load between a plurality of paths; and
optimizing the use of network resources.

In this respect, it should be recalled (cf. Wikipedia) that in the field of networks “aggregating links” is a concept describing grouping together a plurality of network interfaces as though there was a single interface, in order to increase data rate beyond the limits of a single link, and possibly in order to ensure that other interfaces take over if a link fails (redundancy principle).

A particularly advantageous example application of the MPTCP protocol is transferring voluminous files while using the resources of the file transfer protocol (FTP). A device acting as an FTP client can make use dynamically of all of the available paths that enable that device to access an FTP server, providing the server is suitable for making use of the various MPTCP connections set up by the FTP client. The time required to transfer data is thus significantly reduced compared with a TCP connection.

In the context of MPTCP, the term “sub-flow” is used to designate a TCP connection that relies on using one of the available IP address and port number pairs. As a result, an MPTCP connection is an aggregation of TCP sub-flows. By way of example, FIG. 1 shows an MPTCP connection between a terminal A and a terminal B; the initial sub-flow is set up between address A1 of terminal A and address B1 of terminal B; subsequently, an additional sub-flow is set up between address A2 of terminal A and address B1 of terminal B.

Operating systems present applications with dedicated interfaces known as application programming interfaces (APIs) enabling them to interact with the TCP and IP layers. The conventional API presented to TCP/IP applications is the “socket” interface. A “socket” is characterized by a plurality of “attributes” such as “local socket address”, “remote socket address”, and “protocol”. New extensions (MPTCP API) have been specified by the IETF in document RFC 6897 to enable applications to control MPTCP connections. It should be observed that the MPTCP API is an extension of the TCP API.

The term “MPTCP connection table” designates a software structure used to group together all of the TCP sub-flows associated with a given MPTCP connection. Several attributes can be used for characterizing an MPTCP connection table. In addition to the above-mentioned conventional TCP/IP attributes, values given to attributes that are specific to the MPTCP protocol. The values of these attributes of the connection table are controlled via the MPTCP API.

An MPTCP connection is initialized like any conventional TCP connection, except that the MP_CAPABLE option (meaning that the sender terminal is compatible with MPTCP extensions) is included in the message containing the connection initialization flag (SYN) and in the subsequent messages. An MPTCP terminal can inform the remote terminal about the availability of an additional IP address by using the ADD_ADDR option without necessarily creating an associated sub-flow.

Nevertheless, signaling a plurality of IP addresses that are available and suitable for use for communicating with a party can lead to failure to set up certain TCP sub-flows because the external IP addresses as perceived by the remote terminals need not be the same as those that are visible locally. That is why the ADD_ADDR option of the MPTCP protocol includes an address identifier (address ID) that is used for identifying an available IP address without ambiguity. In the state of the art, this provision is supposed to avoid problems induced by the presence of a network address translator (NAT) on the path followed by the packets between the two terminals that have set up an MPTCP connection. The ADD_ADDR option is also used for transmitting a port number in the event of one of the MPTCP terminals not using the same port number for all of the available IP addresses.

Likewise, the MPTCP protocol has provisions that are intended specifically to make it possible to pass through firewalls. More precisely, the specification of the MPTCP protocol stipulates that the sequence numbers as indicated in the TCP header are specific to each sub-flow, while the sequence number given in the data sequence signal (DSS) option of the MPTCP protocol serves to associate these sub-flows with the same MPTCP connection.

The MPTCP protocol thus seeks to counter the massive proliferation in present-day networks of “middle boxes” (i.e. pieces of equipment in intermediate positions in a communication chain) such as NATs, and firewalls. In addition, document RFC 6824 makes provision that in the event of a failure of an attempt to set up an MPTCP connection, the connection transforms automatically into a simple TCP connection.

Unfortunately, in spite of all those precautions, other problems can arise when attempting to set up an MPTCP connection. For example:
certain MPTCP options, or indeed all of them, may be filtered (i.e. removed) by intermediate piece of equipment (e.g. a NAT or a firewall) situated in series between two MPTCP peers, as shown in FIG. 2;
even if the above-mentioned SYN MPTCP messages are successfully exchanged between two MPTCP peers, intermediate pieces of equipment can filter the above-mentioned DSS options from the data packets; under such circumstances, and as shown in FIG. 3, the attempt at setting up an MPTCP connection cannot succeed, with the consequence of falling back on a simple TCP connection, as in the situation shown with reference to FIG. 2; and
it may happen that a first TCP sub-flow is established successfully, but that multiple sub-flows fail to be set up for lack of multiple paths that are compatible with MPTCP extensions.

Unfortunately, the authors of the present invention have found that the presence of such intermediate pieces of equipment has the effect of significantly lengthening the time required for setting up TCP sub-flows, and consequently has a negative impact on the quality of service of a communication, as perceived by the user.

### SUMMARY

The present invention thus relates to a method of communication between a first client device and a second client device. Said method is remarkable in that it comprises the following steps:

a) said first client device or a first relay device connected to the first client device sending to said second client device or to a second relay device connected to the second client device an initialization message for a TCP connection on a path referred to as the “first” path, said initialization message including a TCP option indicating that the first client device or the first relay device seeks to participate with the second client device or the second relay device both in a TCP connection and in a multipath connection over said first path;

b) said first client device or first relay device and said second client device or second relay device participating in a TCP connection and in a multipath connection between them over the first path; and

c) if at least one of the two client devices or one of the two relay devices observes an anomaly concerning said multipath connection, the first client device and the second client device using said TCP connection to exchange payload data.

Thus, according to the invention, a simple TCP connection and a multipath connection are initialized together. This simple TCP connection is said to be a “dual” TCP connection. When two peers set up a multipath connection:
if neither of them detects an anomaly, they can incorporate the dual TCP connection in the multipath connection;
in contrast, if an anomaly is detected while setting up the multipath connection (e.g. too long a time delay for setting up the multipath connection compared with the time delay observed for the dual TCP connection, or the absence of certain MPTCP options when the two peers are configured to perform MPTCP), the peers can make use of the dual TCP connection in order to exchange payload data, so as to guarantee continuity of service; this fallback onto a simple TCP connection advantageously does not give rise to any additional delay since the TCP connection is indeed already being set up or is already in place.

By means of these provisions, when the second client device or second relay device is compatible with multipath connections, setting up said multipath connection is made easier. Specifically, it can happen that the second client device or the second relay device finds it difficult to accept an additional connection (i.e. the multipath connection or the dual TCP connection) with the same peer (specifically the first client device or the first relay device), e.g. because of provisions for protecting the network against denial of service (DoS) attacks, or because of a configuration of the second client device or the second relay device (e.g. a web server accessible using HTTP) that is intended to limit the number of connections per client. That is why in the invention, the first client device or the first relay device indicates explicitly to the second client device or the second relay device that it desires a multipath connection to be associated with the simple TCP connection that is being set up and over the same path.

It may be observed that the invention can be performed by any TCP compatible client device. The client device may have one or more external addresses, or one or more network interfaces (which may be logical or physical). However the client device might have only one interface if it is situated behind a relay device (such as a router or a residential gateway) connected to one or more networks and compatible with multipath TCP options.

The communications devices involved (client devices and relay devices) may be of any type, e.g. a terminal, a router, or a residential gateway.

By means of the invention, these communications devices can discover the capabilities of any “intermediate equipment” (such as the above-mentioned middle boxes) and can anticipate the failure of multipath TCP connections. This shortens the delay for setting up multipath connections and thus clearly significantly improves the quality of user experience.

Furthermore, such a device can:
adjust its behavior as a function of how it is attached to a network (e.g. when attached to a new network, non-availability of a network interface, or detecting “intermediate equipment”);
decide, without any risk of degrading the quality of communication with the other party, to activate a multipath connection or to deactivate an ongoing multipath connection or all ongoing multipath connections, or indeed to add a new TCP sub-flow to an ongoing multipath connection; and
reestablish a multipath connection if there has been a change in the circumstances that previously led to a fallback to a simple TCP connection.

Furthermore, said multipath connection may advantageously comply with the MPTCP protocol, so as to benefit from the provisions of that protocol as mentioned briefly above.

According to particular characteristics, during said step b), said second client device or second relay device initializes said multipath connection after receiving said message for initializing a TCP connection sent by said first client device or first relay device during said step a).

By means of these provisions, it is ensured that the first client device or first relay device does not make pointless attempts to initialize a multipath connection with the second client device or second relay device when that device is not compatible with multipath connection connections.

It may be observed that the invention applies particularly to the situation in which there exist at least two possible communication paths between a first client device and a second client device, even if only one usable path exists when initializing the TCP connection. The invention is preferably implemented for each of the possible communication paths between the two client devices, as a result of that path being discovered by one or the other of the client devices.

That is why, according to other particular characteristics, if no anomaly concerning said multipath connection is observed, and if there exists between said first and second client devices at least one path other than said first path, the method includes:
verifying whether said other path is compatible with TCP options specific to multipath connection; and
if said verification is positive, the first and second client devices exchanging payload data between them within the multipath connection via said other path in addition to said first path.

By means of these provisions, maximum benefit is obtained from the possibilities made available by the multipath connection.

According to even more particular characteristics, in order to verify whether said other path is compatible, the first client device or first relay device, or the second client device or second relay device sends a sub-flow initialization message over said other path within said multipath connection communication, said sub-flow initialization message including a TCP option indicating that said sub-flow should not be used for exchanging payload data until said verification has been concluded in positive manner.

By means of these provisions, the two peers can conveniently test new paths (possibly giving rise to new sub-flows) within the multipath connection communication, without any risk of degrading the quality of the communication.

Correspondingly, the invention provides various devices.

Thus, firstly, the invention provides a communications device, referred to as the “first” communications device, that possesses means for participating in a TCP communication. The first communications device is remarkable in that it also possesses means for:
sending to another communications device, referred to as the “second” communications device, an initialization message for initializing a TCP connection over a path, referred to as the “first” path, said initialization message including a TCP option indicating that said first communications device seeks to participate with said second communications device both in a TCP connection and in a multipath connection over said first path;
also initializing a multipath connection with the second communications device over the first path; and
if it observes an anomaly concerning said multipath connection, using said TCP connection to exchange payload data with the second communications device.

Secondly, the invention also provides a communications device, referred to as the “second” communications device, that possesses means for participating in a TCP communication. Said second communications device is remarkable in that it further comprises means for:
receiving from another communications device, referred to as the “first” communications device, an initialization message for initializing a TCP connection over a path, referred to as the “first” path, said initialization message including a TCP option indicating that said first communications device seeks to participate with said second communications device both in a TCP connection and in a multipath connection over said first path;
initializing the multipath connection with the first communications device over the first path; and
if it observes an anomaly relating to said multipath connection, using said TCP connection for exchanging payload data with the first communications device.

According to particular characteristics, said first communications device or said second communications device may further include means for use, when there exists at least one path other than said first path connecting it to said other communications device, to send an initialization message for initializing a sub-flow over said other path within said multipath connection communication, said message for initializing a sub-flow including a TCP option indicating that said sub-flow should not be used for exchanging payload data prior to a positive conclusion to verifying whether said other path is compatible with the TCP options specific to the multipath connection.

The advantages made available by these communications devices are essentially the same as those made available by the corresponding methods set out briefly above.

Said first communications device or said second communications device may comprise a client device, such as a user terminal, or a relay device, such as a router or a residential gateway.

It should be observed that it is possible to make these communications devices in the context of software instructions and/or in the context of electronic circuits.

The invention also provides a computer program downloadable from a communications network and/or stored on a computer-readable medium and/or executable by a microprocessor. The computer program is remarkable in that it comprises instructions for executing steps of the communications method set out briefly above, when executed on a computer.

The advantages made available by the computer program are essentially the same as those made available by said method.

Other aspects and advantages of the invention appear on reading the following detailed description of particular implementations given as non-limiting examples.

### BRIEF DESCRIPTION OF THE DRAWINGS

The description refers to the accompanying figures, in which:

FIG. 1, described above, shows an aggregation of TCP sub-flows forming a single MPTCP connection;

FIG. 2, described above, shows the failure of an attempt at setting up an MPTCP sub-flow to the terminal B from a terminal A as a result of MPTCP options being filtered by intermediate equipment;

FIG. 3, described above, shows the failure of an attempt at setting up an MPTCP sub-flow to the terminal B from a terminal A as a result of DSS options filtered by intermediate equipment;

FIG. 4 shows the DUAL option of the invention;

FIG. 5 shows a network configuration example having three terminals D1, D2, and D3;

FIG. 6 shows TCP sub-flows established between the terminals D1 and D3 of FIG. 5;

FIG. 7 shows the PROBE option of the invention; and

FIG. 8 shows an example of applying the invention to a network configuration having a terminal T1 located behind a relay device R.

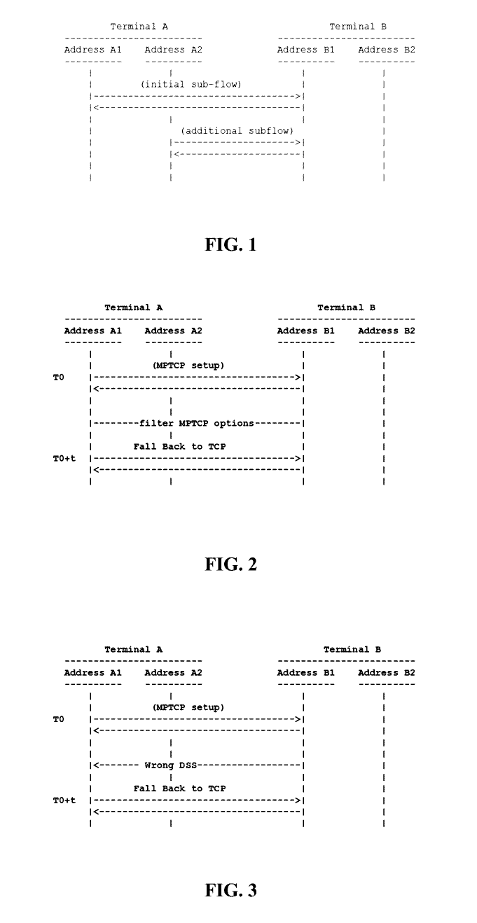

### DETAILED DESCRIPTION OF ILLUSTRATIVE EMBODIMENTS

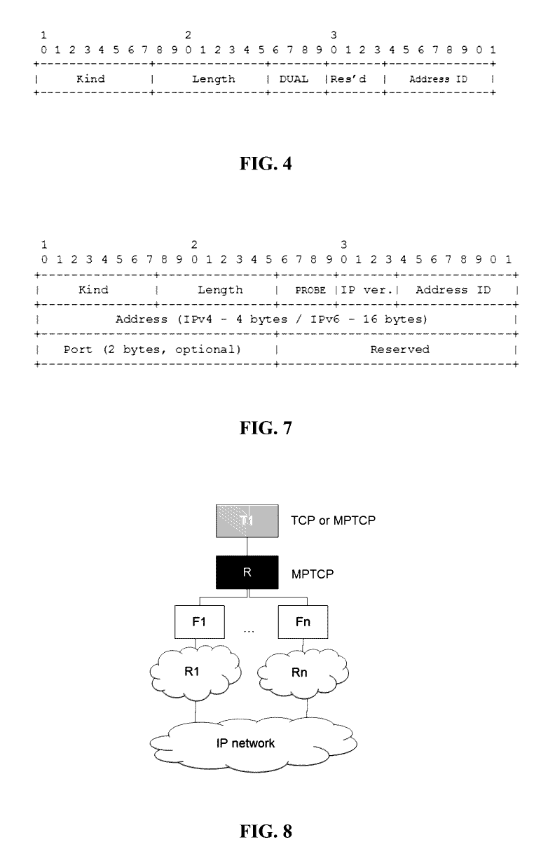

The invention proposes a novel TCP option, referred to as “DUAL”, and shown in FIG. 4. This DUAL option comprises the following fields:
“Kind”: indicates the kind of option; this field includes a unique identifier describing the nature of the TCP option;
“Length”: this field gives the Length of the option, expressed in bytes;
“DUAL”: this field indicates the sub-kind of this multipath connection option in order to distinguish in non-ambiguous manner the DUAL option from other multipath connection options;
“Reserved”: this field is reserved for future use; and
“Address ID”: this field gives the identifier of an IP address.

The DUAL option is used by a terminal to specify to a peer that the TCP connection is a dual connection, i.e. that a multipath connection needs to be initialized together with the TCP connection.

The invention also proposes a plurality of novel attributes to be included in the multipath connection tables. These attributes are as follows:
PATH_CHECKED: this field is set to “1” to indicate that a TCP sub-flow is compatible with multipath connection extensions, and it is set to “0” otherwise; and
DUAL: this field is set to “1” to indicate that a dual TCP connection is active together with this multipath connection; the value “0” is used to indicate that no simple TCP connection is associated with this multipath connection.

The invention applies in general manner to any protocol relating to multipath connection TCP connections. There follows a description of the invention being applied to the MPTCP protocol as described briefly above. In particular, the above-mentioned MPTCP API needs to be modified so as to make it possible to transmit the values of the DUAL and PATH_CHECKED attributes of the invention to applications.

In conventional manner, the MPTCP protocol has various provisions, including in particular definitions of the following TCP options:
MP_CAPABLE: this option is used to inform the remote terminal that the sending terminal is compatible with MPTCP extensions;
ADD_ADDR: this option is used to add a new address; it includes an optional two-octet field serving also to provide a port number, where appropriate;
REMOVE_ADDR: this option is used for removing an address;
MP_PRIO: this option is used for modifying the priority of a connection;
MP_JOIN: this option is used for identifying the TCP connection that is associated with setting up a new sub-flow;
MP_FAIL: this option is used to return to TCP mode without MPTCP options; and
MP_FASTCLOSE: this option is used for closing an MPTCP connection quickly.

The MPTCP protocol may be activated in several modes:
native mode: two MPTCP terminals set up all of the sub-flows that correspond to the available address and port numbers, and make use of all of these sub-flows;
primary mode: two MPTCP terminals signal sub-flows, but only a subset of these sub-flows is actually used for transferring data;
secondary mode: in the event of the “primary” sub-flow subset being unavailable (or overloaded), a “secondary” subset of sub-flows is then requested to ensure continuity of the MPTCP connection; and
fallback mode: two MPTCP terminals use a single sub-flow; in the event of failure, traffic is transferred to a new sub-flow that is created for this purpose.

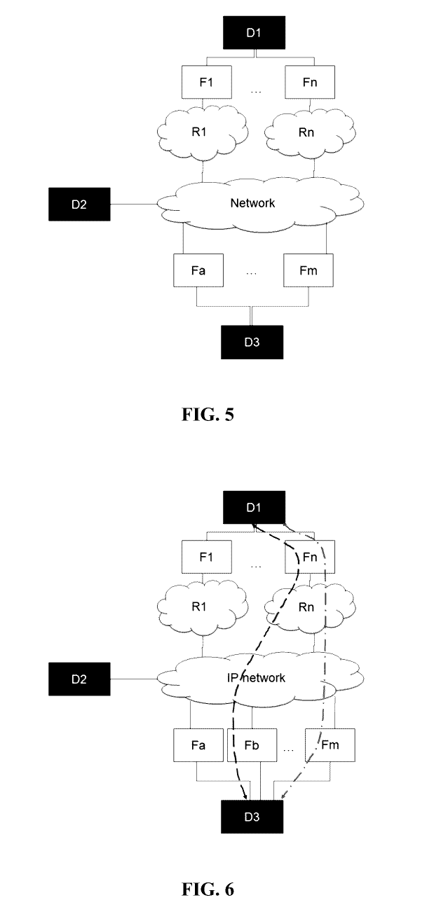

FIG. 5 shows a network configuration example having three terminals D1, D2, and D3. In this figure there can be seen:
a terminal D1 connected to one or more IP networks via n connection nodes (F1, F2, . . . , Fn) and n respective access networks R1, R2, . . . , Rn; these connection nodes may host NAT, firewall, etc. functions or they may be IP routers that do not include any advanced service function such as a NAT or a firewall; it is assumed that:
   F1 filters MPTCP options;
   F2 filters only the MPTCP options of data packets; and
   Fn neither filters nor modifies any MPTCP option;
a terminal D2 connected to an IP network via a single connection node; it is assumed that D2 is MPTCP-compatible and that it has been allocated a single IP address; and
a terminal D3 connected to one or more IP networks via m connection nodes (Fa, Fb, . . . , Fm); these nodes may host NAT, firewall, etc. functions or they may be IP routers that do not include any advanced service function such as a NAT or a firewall; it is assumed that:
   Fa filters MPTCP options;
   Fb neither filters nor modifies any MPTCP option; and
   Fm neither filters nor modifies any MPTCP option.

As shown in FIG. 6, the valid MPTCP paths between D1 and D2 are then as follows:
the path passing via Fn and Fb; and
the path passing via Fn and Fm.

The terminals D1 and D3 cannot use MPTCP if paths other than those two paths are selected for exchanging data between D1 and D3. Furthermore, D1 and D3 do not have means for identifying the cause of a failure to set up a multipath connection. In particular, they cannot determine whether the cause of the failure is a failure of intermediate equipment at D1, at D3, or in between.

By way of example, there follows a description of several implementations of the invention in which it is assumed that a terminal T1 seeks to set up an MPTCP connection with a terminal T2.

In a first implementation, the following steps are performed.

During a step E1, the terminal T1 initializes a TCP connection on a first path together with an MPTCP connection to the terminal T2. The terminal T1 includes the DUAL option in its initialization message in order to inform the terminal T2 that it seeks to participate therewith both in a TCP connection and in an MPTCP connection over this first path. The terminal T1 can initialize both connections simultaneously or with a (positive or negative) time offset between the two connections.

During a step E2, the terminal T2 responds to the terminal T1 with a SYN/ACK message that does not contain the MP_CAPABLE option. The terminal T1 deduces therefrom that the terminal T2 is not compatible with MPTCP extensions.

Finally, during a step E3, the terminal T1 ends the MPTCP connection, and the two terminals exchange data via the TCP connection.

It should be observed that the two terminals thus exchange data successfully over the TCP connection without this fallback causing any delay since the TCP connection was already set up.

In a second implementation, the following steps are performed.

During a step E′1, the terminal T1 initializes a TCP connection over a first path to the terminal T2. The terminal T1 includes the DUAL option in its initialization message in order to inform the terminal T2 that it seeks to participate therewith both in a TCP connection and in an MPTCP connection over the first path. The terminal T2, which is compatible with MPTCP extensions, responds to the terminal T1 by initializing an MPTCP connection.

During a step E′2, the terminal T2 detects an anomaly (e.g. the absence of one of the MPTCP options), and it notifies the terminal T1 of the fact that it has observed an anomaly.

Finally, during a step E′3, both terminals end the MPTCP connection, and they exchange data via the TCP connection.

It should be observed that in this situation, once more, the two terminals are successful in exchanging data over the TCP connection without the fallback leading to any delay since the TCP connection was already set up.

In a third implementation, the following steps are performed.

During a step E″1, the terminal T1 initializes a connection TCP over a first path to the terminal T2. The terminal T1 includes the DUAL option in its initialization message in order to inform the terminal T2 that it seeks to participate therewith both in a TCP connection and in an MPTCP connection over the first path. The terminal T2, which is compatible with MPTCP extensions, responds to the terminal T1 by initializing an MPTCP connection.

During a step E″2, since neither of the two terminals has detected any anomaly while exchanging data using the MPTCP connection, they can end the TCP connection and maintain only the MPTCP connection. The two terminals can exchange messages to coordinate closure of the TCP connection; this coordination makes it possible to off-load the TCP connection and to use only the MPTCP connection for sending data. In a variant, the two terminals may decide to end the TCP connection only at the end of step E″3 as described below. In yet another variant, they may maintain the TCP connection in order to facilitate changeover in the event of the multipath connections that are compatible with MPTCP becoming unavailable subsequently.

During a step E″3, since the first MPTCP sub-flow has been successfully set up, it is verified whether any paths (and thus TCP sub-flows) between the terminals T1 and T2 other than said first path are compatible with MPTCP extensions.

By way of example, these other paths may be discovered by using a dynamic IP address allocation protocol such as dynamic host configuration protocol (DHCP), or by a mapping creation mechanism such as port control protocol (PCP), universal plug and play (UPnP), Internet gateway device (IGD), or session traversal utilities for NAT (STUN). In this respect, it should be recalled that a “mapping” designates the association between an internal IP address and an internal port number with an external IP address and an external port number. With a NAT function, the internal IP address and the internal port number are input data items, while the external IP address and the external port number are allocated by the NAT function. With a firewall, the internal and external information is identical. A mapping may include other information, such as the IP address and the port number of the correspondent or an identifier of the communications protocol in use.

By way of example, this verification of compatibility with MPTCP extensions may be performed by the terminals T1 and T2 themselves, by simulating the initialization of TCP sub-flows using a TCP option of the present invention, referred to as “PROBE”, and as is illustrated in FIG. 7.

The presence of the PROBE option is an indication to the remote terminal that the sub-flow in question should preferably not be used (temporarily) for exchanging payload data, but that it is being initialized in order to verify whether the underlying path is compatible with multipath connection TCP extensions. The use of the PROBE option is not exclusive to the terminal that initiated the multipath connection TCP connection. Thus, test sub-flows (including the PROBE option) may be set up at the initiative of one of the peers or of both of them together. The two peers T1 and T2 can initialize, each at its own end, a test sub-flow associated with the same path. A plurality of test sub-flows may be initialized simultaneously.

The PROBE option has the following fields:
“Kind”: indicates the kind of option; this field includes a unique identifier describing the nature of the TCP option;
“Length”: this field gives the Length of the option, expressed in bytes;
“PROBE”: this field specifies the sub-kind of this multipath connection option in order to distinguish in non-ambiguous manner the PROBE option from other multipath connection options;
“IP version”: this field specifies the address family (IPv4, IPv6) to which the address included in the “Address” field belongs;
“Address ID”: this field gives the identifier of an IP address;
“Address”: this field is used to include an IP address; it may be an IPv4 address or an IPv6 address;
“Port”: this field is optional; if present it gives a port number; and
“Reserved”: this field is reserved for future use; for example this field may be used for requesting the remote peer to initialize a sub-flow in order to test the return path (since routing is asymmetrical), to inject certain types of packet, or to regulate the data rate of the sub-flow.

Finally, where appropriate, during a step E″4, for at least one of the potential paths between the terminals T1 and T2 other than said first path:
if, after said verification, the other path is found to be compatible with MPTCP options, then the attribute PATH_CHECKED associated with the path is set to “1”; the two terminals can then, where necessary, use the TCP sub-flow associated with this other path in addition to the TCP sub-flow associated with the first path in order to exchange data within the MPTCP connection; and
in contrast, if this other path is found to be incompatible with MPTCP options, the PATH_CHECKED attribute associated with this path is set to “0”; this other path naturally cannot be used by the terminals T1 and T2 to set up an additional TCP sub-flow between them, or to initialize another dual TCP connection associated with another MPTCP connection involving these two peers.

It should be observed that optionally, a terminal may verify potential compatibility of other paths even before initializing the first MPTCP connection.

So long as the dual TCP connection has not been closed, the participants in an MPTCP connection can execute said test procedure each time there is a change to a network access condition, in particular in the event of detecting one or more new networks or of detecting new paths:
if the test is positive, the two terminals can then switch over from the dual TCP connection set up together with an MPTCP connection to the MPTCP connection;
conversely, if the test is negative, i.e. if none of the multipath connections is compatible with MPTCP options, then the MPTCP connection switches over to the dual TCP connection.

FIG. 8 shows an example application of the invention to a network configuration having a TCP or MPTCP terminal T1 placed behind a relay device R such as a router or a residential gateway that is compatible with MPTCP. The relay device R performs the present invention for communicating with remote terminals.

The relay device R is connected to one or more IP networks via n connection nodes (F1, F2, . . . , Fn) and n respective access networks R1, R2, . . . , Rn; these connection nodes may host NAT, firewall, etc. functions, or they may be IP routers that do not include any advanced service function such as a NAT or a firewall.

The invention may be implemented within nodes of communications networks, e.g. terminals, routers, or gateways, by using software and/or hardware components.

The software components may be incorporated in a conventional computer program for managing a network node. That is why, as mentioned above, the present invention also provides a computer system. The computer system comprises in conventional manner a central processor unit using signals to control a memory, together with an input unit or an output unit. The computer system may also be used for executing a computer program including instructions for performing any of the communications methods of the invention.

Specifically, the invention also provides a computer program as set out briefly above. The computer program may be stored on a computer-readable medium and it may be executed by a microprocessor. The program may use any programming language and may be in the form of source code, object code, or code intermediate between code source and object code, such as in a partially compiled form, or in any other desirable form.

The invention also provides a non-removable, or a partially or totally removable data medium that is computer readable and that includes instructions of a computer program as set out briefly above.

The data medium may be any entity or device capable of storing the program. By way of example, the medium may comprise storage means such as a read only memory (ROM), e.g. a compact disk (CD) ROM or a microelectronic circuit ROM, or magnetic recording means, such as a hard disk, or indeed a universal serial bus (USB) flash drive.

Furthermore, the data medium may be a transmissible medium such as an electrical or optical signal, suitable for being conveyed via an electrical or optical cable, by radio, or by other means. The computer program of the invention may in particular be downloaded from an Internet type network.

In a variant, the data medium may be an integrated circuit in which the program is incorporated, the circuit being adapted to execute or to be used in the execution of any of the communications methods of the invention.

Although the present disclosure has been described with reference to one or more examples, workers skilled in the art will recognize that changes may be made in form and detail without departing from the scope of the disclosure and/or the appended claims.

1. A communication method between a first client device and a second client device, the method comprising the following acts:
a) said first client device or a first relay device connected to the first client device sending to said second client device or to a second relay device connected to the second client device an initialization message for a transmission control protocol (TCP) connection on a path referred to as the “first” path, said initialization message including a TCP option indicating that the first client device or the first relay device seeks to participate with the second client device or the second relay device both in a TCP connection and in a multipath connection over said first path;
b) said first client device or first relay device and said second client device or second relay device participating in a TCP connection and in a multipath connection between them over the first path; and
c) if at least one of the two client devices or one of the two relay devices observes an anomaly concerning said multipath connection, the first client device and the second client device using said TCP connection to exchange payload data.

2. The communication method according to claim 1, wherein during said act b), said second client device or second relay device initializes said multipath connection after receiving said message for initializing a TCP connection sent by said first client device or first relay device during said act a).

3. The communication method according to claim 1 wherein, if no anomaly concerning said multipath connection is observed, and if there exists between said first and second client devices at least one path other than said first path, the method includes:
verifying whether said other path is compatible with TCP options specific to multipath connection; and
if said verification is positive, the first and second client devices exchanging payload data between them within the multipath connection via said other path in addition to said first path.

4. The communication method according to claim 3, wherein, in order to verify whether said other path is compatible, the first client device or first relay device, or the second client device or second relay device sends a sub-flow initialization message over said other path within said multipath connection communication, said sub-flow initialization message including a TCP option indicating that said sub-flow should not be used for exchanging payload data until said verification has been concluded in positive manner.

5. The communication method according to claim 1, wherein said multipath connection makes use of the multipath TCP (MPTCP) protocol.

6. A communications device, referred to as a “first” communications device, comprising:
a non-transitory computer-readable medium comprising instructions stored thereon; and
a processor, which when executing the instructions configures the first communications device to perform acts comprising:
participating in a transmission control protocol (TCP) communication;
sending to another communications device, referred to as a “second” communications device, an initialization message for initializing a TCP connection over a path, referred to as a “first” path, said initialization message including a TCP option indicating that said first communications device seeks to participate with said second communications device both in a TCP connection and in a multipath connection over said first path;
also initializing a multipath connection with the second communications device over the first path; and
if the first communications device observes an anomaly concerning said multipath connection, using said TCP connection to exchange payload data with the second communications device.

7. A communications device, referred to as a “second” communications device, comprising:
a non-transitory computer-readable medium comprising instructions stored thereon; and
a processor, which when executing the instructions configures the second communications device to perform acts comprising:
participating in a transmission control protocol (TCP) communication;
receiving from another communications device, referred to as a “first” communications device, an initialization message for initializing a TCP connection over a path, referred to as a “first” path, said initialization message including a TCP option indicating that said first communications device seeks to participate with said second communications device both in a TCP connection and in a multipath connection over said first path;
initializing the multipath connection with the first communications device over the first path; and
if the second communications device observes an anomaly relating to said multipath connection, using said TCP connection for exchanging payload data with the first communications device.

8. The communications device according to claim 6, wherein the instructions further configure the first communications device to perform acts comprising:
when there exists at least one path other than said first path connecting the first communications device to said second communications device, to send an initialization message for initializing a sub-flow over said other path within said multipath connection communication, said message for initializing a sub-flow including a TCP option indicating that said sub-flow should not be used for exchanging payload data prior to a positive conclusion to verifying whether said other path is compatible with the TCP options specific to the multipath connection.

9. The communications device according to claim 6, comprising a client device.

10. The communications device according to claim 6, comprising a relay device.

11. A non-transitory computer-readable medium comprising computer program code instructions for executing acts of a communications method between a first client device and a second client device, when the instructions are executed by a processor, wherein the method comprises the following acts:
a) said first client device or a first relay device connected to the first client device sending to said second client device or to a second relay device connected to the second client device an initialization message for a transmission control protocol (TCP) connection on a path referred to as the “first” path, said initialization message including a TCP option indicating that the first client device or the first relay device seeks to participate with the second client device or the second relay device both in a TCP connection and in a multipath connection over said first path;
b) said first client device or first relay device and said second client device or second relay device participating in a TCP connection and in a multipath connection between them over the first path; and
c) if at least one of the two client devices or one of the two relay devices observes an anomaly concerning said multipath connection, the first client device and the second client device using said TCP connection to exchange payload data.

12. (canceled)

13. The communications device according to claim 7, wherein the instructions further configure the second communications device to perform acts comprising:
when there exists at least one path other than said first path connecting the second communications device to said first communications device, to send an initialization message for initializing a sub-flow over said other path within said multipath connection communication, said message for initializing a sub-flow including a TCP option indicating that said sub-flow should not be used for exchanging payload data prior to a positive conclusion to verifying whether said other path is compatible with the TCP options specific to the multipath connection.

14. The communications device according to claim 7, comprising a client device.

15. The communications device according to claim 7, comprising a relay device.
